(19) United States
(12) Patent Application Publication
(10) Pub. No.: US 2007/0083821 A1
(43) Pub. Date: Apr. 12, 2007

(54) Creating viewports from selected regions of windows

(75) Inventors: Zachary Adam Garbow, Rochester, MN (US); Frederick Allyn Kulack, Rochester, MN (US); Kevin Glynn Paterson, San Antonio, TX (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/246,829

(22) Filed: Oct. 7, 2005

(51) Int. Cl. G06F 9/00

(52) U.S. Cl. 715/781

(57) ABSTRACT

A method, apparatus, system, and signal-bearing medium that, in an embodiment, create a viewport based on a selected region of a source window, determine data that is within the selected region, and display the data in the viewport. The source window is minimized to an icon, which represents the source window, but which is different from the data displayed in the viewport. In response to additional data being received, the additional data is displayed in the viewport if the additional data is within the selected region. In an embodiment, the additional data is compared to the data already displayed in the viewport, and if the additional data fulfills a notification criteria, a notification that the criteria was fulfilled is presented via a notification technique. In various embodiments, the notification criteria may include a percent of the data that was changed, an area in the viewport that was changed, a color that was changed, text that was changed, an image that was changed, a rate of change, and a threshold that was reached in multiple viewports. In an embodiment, the viewport may be resized or scrolled, and in response to the resizing or scrolling, the selected region is updated. Commands directed to the viewport are sent to the source application.

### FIELD

This invention generally relates to user interfaces for computer systems and more specifically relates to creating viewports from selected regions of windows in a user interface.

### BACKGROUND

The development of the EDVAC computer system of 1948 is often cited as the beginning of the computer era. Since that time, computer systems have evolved into extremely sophisticated devices, and computer systems may be found in many different settings. Computer systems typically include a combination of hardware, such as semiconductors and circuit boards, and software, also known as computer programs. As advances in semiconductor processing and computer architecture push the performance of the computer hardware higher, more sophisticated computer software has evolved to take advantage of the higher performance of the hardware, resulting in computer systems today that are much more powerful than just a few years ago.

One of the most important developments in making computers not only more powerful, but easier to use, was the development of sophisticated user interfaces. Early computer systems were programmed with a series of switches or buttons and provided little relevant feedback during the operation of the computer system. This type of interface proved cumbersome and, accordingly, increasingly more functional and interactive interfaces were developed to extend the functionality of computer systems.

The next generation of user interface was the “command line interface.” Using a command line interface, the user interacted with the computer system by typing a specific command on a keyboard to instruct the computer regarding the desired operation to be performed. The command line interface was not intuitive, however, and still limited the use of computers to those who had the time and desire to learn a large number of cryptic commands.

Recognizing the growing need for a more user-friendly interface, computer engineers and programmers developed the Graphical User Interface (GUI). A GUI uses visual representations of common items to allow a user to operate a computer system. In most GUI-based systems, various windows, icons, symbols, menus, etc. are manipulated or activated by a computer user via a pointing device (e.g., a keyboard, mouse, trackball, touchpad, trackpad, or speech recognition device), which allows the user to give instructions to the computer. The movement of the pointing device is usually translated to the movement of an animated arrow or cursor, displayed on the computer screen. By moving the pointing device, the user can position the cursor at various locations on the computer screen. Then, by activating a button on the pointing device, the user can invoke various commands and options on the graphical user interface.

Most graphical user interfaces make extensive use of windows. A window is usually, but not always, a rectangular portion of the display on a computer monitor that presents its contents seemingly independently of the rest of the screen. A window is typically manipulated by (1) opening and closing the window, e.g., by selecting an icon to start a program, (2) moving the window to any area of the screen by dragging (e.g., positioning the pointer over the window and moving the mouse or other pointing device with a button held down), (3) repositioning the window, so that the window appears to be behind or in front of other windows or objects on the screen, (4) adjusting the size (i.e., horizontal and/or vertical dimensions) and (5) scrolling to any section of the window contents, e.g., by using scroll bars along the bottom and right edges of the window, or by using a mouse wheel or keyboard commands.

The size of most windows can be adjusted over a wide range including full screen, a fraction of the screen, and more than the full screen. In the latter case, the desired section of the window can be viewed by moving the window to expose it. Windows can also be minimized, which results in their being replaced by an icon and/or their name, usually in a strip along the bottom of the screen, without actually closing the underlying application program. This flexibility is made possible by the various parts that can constitute a window. The parts of a window may include frames, vertical and horizontal scrollbars, drag strips (often along the top for dragging the entire window and along the other edges and lower comers for changing window size), buttons (for closing, maximizing and minimizing) and tabs (for moving among pages in a window).

Another feature of windows is the ability for multiple windows to be open simultaneously. This is particularly valuable in a multitasking environment, i.e., an operating system in which multiple programs can run seemingly simultaneously and without interfering with each other. Each window can display a different application, or it can display different files that have been opened or created with a single application.

Multiple open windows can be arranged with respect to each other in a variety of ways. They can be arranged so that they are contiguous and do not overlap (tiled windows) or so they do overlap (overlaid windows). Overlaid windows resemble a stack of documents lying on top of one another, with only the upper-most window displayed in full. Any window can be moved to the top of the stack and made the active window (i.e., ready for receiving user input) by positioning the pointer in any portion of it that is visible and clicking a mouse button. When applications are launched, they may open in a single window or multiple windows.

Various types of windows exist, and their functions and appearances can vary substantially. For example, child windows are windows that are opened either automatically or as a result of some user activity when using a parent window. They can range in functionality from the very simple to the full complement of controls. Message windows, also referred to as dialog boxes or pop-up messages are a type of child window. A dialog box is usually a small and very basic window that is opened by a program or by the operating system to provide information to the user and/or obtain information (or at least a response) from the user, including setting options or issuing commands.

Because the display screen may contain so many windows, and because some windows may pop up or open unexpectedly in response to asynchronous events, users are often deluged with an overwhelming assortment of attention-demanding windows, popups, and status indicators. With many of these windows, the user waits for a change to be made in the output, and this change in status indicates that further action needs to be taken; whereas, static content (no change) indicates no further attention is needed. This paradigm of waiting for a change and then taking action is prevalent in applications such as email, instant messaging (IM), programming output, server consoles, dynamic websites, RSS (Rich Site Summary) feeds, and many others. The result is that users frequently toggle between windows in an attempt to determine the current status of various applications, which hampers the user's productivity. Some applications, such as email and instant messaging, attempt to aid the user by displaying an icon in the taskbar or blinking data to indicate a change of status; however, the user still needs to toggle to the window to determine what change has occurred and whether the change is relevant enough to demand further attention. In addition, the change of status indication might not be at a level that the user desires. For example, an email application might notify the user every time a new email arrives, even if the email application is minimized, while a user who receives a large volume of email might prefer to receive a notification only if multiple emails have arrived.

Thus, a better technique is needed for managing multiple windows simultaneously, allowing users to more efficiently monitor status changes.

### SUMMARY

A method, apparatus, system, and signal-bearing medium are provided that, in an embodiment, create a viewport based on a selected region of a source window, determine data that is within the selected region, and display the data in the viewport. The source window is minimized to an icon, which represents the source window, but which is different from the data displayed in the viewport. In response to additional data being received, the additional data is displayed in the viewport if the additional data is within the selected region. In an embodiment, the additional data is compared to the data already displayed in the viewport, and if the additional data fulfills a notification criteria, a notification that the criteria was fulfilled is presented via a notification technique. In various embodiments, the notification criteria may include a percent of the data that was changed, an area in the viewport that was changed, a color that was changed, text that was changed, an image that was changed, a rate of change, and a threshold that was reached in multiple viewports. In an embodiment, the viewport may be resized or scrolled, and in response to the resizing or scrolling, the selected region is updated. Commands directed to the viewport are sent to the source application.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example user interface for creating regions, according to an embodiment of the invention.

FIG. 3 depicts a block diagram of an example monitor user interface, according to an embodiment of the invention.

FIG. 4 depicts a block diagram of an example data structure for region data, according to an embodiment of the invention.

FIG. 5 depicts a flowchart of example processing for creating a viewport, according to an embodiment of the invention.

FIG. 6 depicts a flowchart of example processing for updating data in a viewport, according to an embodiment of the invention.

FIG. 7 depicts a flowchart of example processing for handling commands received via a monitor user interface, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

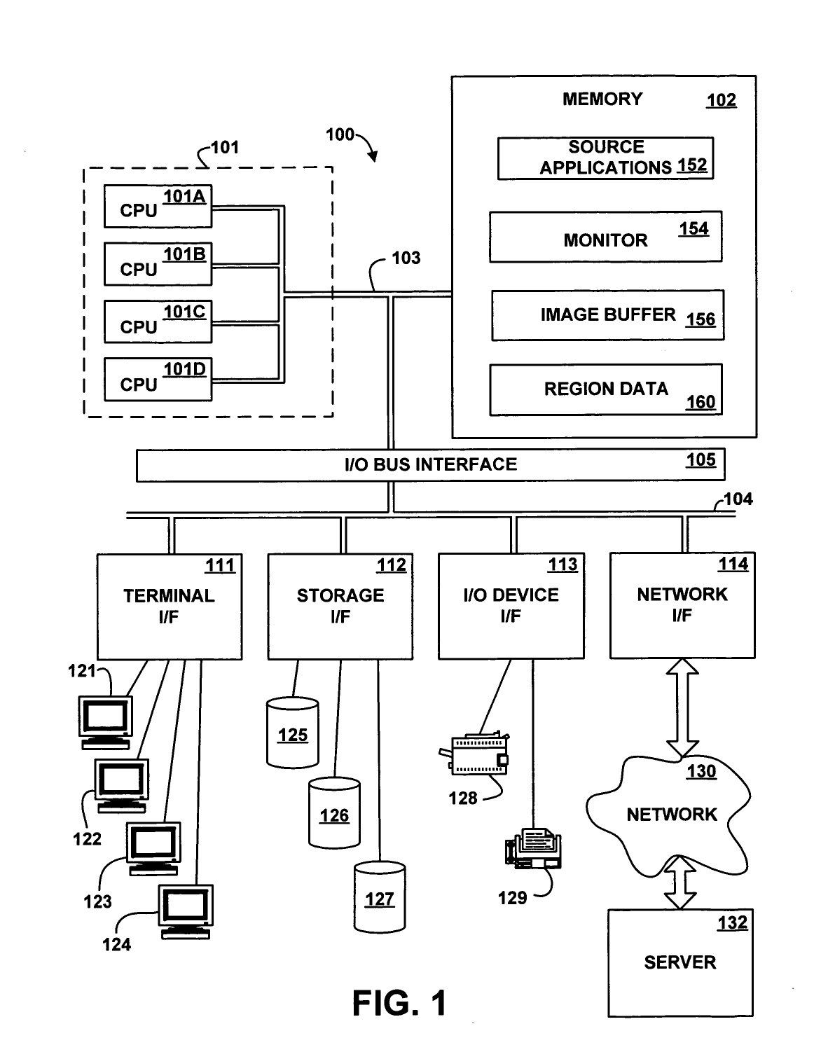

Referring to the Drawings, wherein like numbers denote like parts throughout the several views, FIG. 1 depicts a high-level block diagram representation of a computer system 100 connected to a network 130, according to an embodiment of the present invention. In an embodiment, the hardware components of the computer system 100 may be implemented by an eServer iSeries computer system available from International Business Machines of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, the main memory 102 may exist in multiple levels of caches, and these caches may be further divided by function, so that one cache holds instructions while another holds non-instruction data, which is used by the processor or processors. The main memory 102 may be further distributed and associated with different CPUs or sets of CPUs, as is known in any of various so-called non-uniform memory access (NUMA) computer architectures.

The main memory 102 includes source applications 152, a monitor 154, an image buffer 156, and region data 160. Although the source applications 152, the monitor 154, the image buffer 156, and the region data 160 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the source applications 152, the monitor 154, the image buffer 156, and the region data 160 are illustrated as being contained within the main memory 102, these elements are not necessarily all completely contained in the same storage device at the same time. Further, although the source applications 152, the monitor 154, the image buffer 156, and the region data 160 are illustrated as being separate entities, in other embodiments some of them, or portions of some of them, may be packaged together.

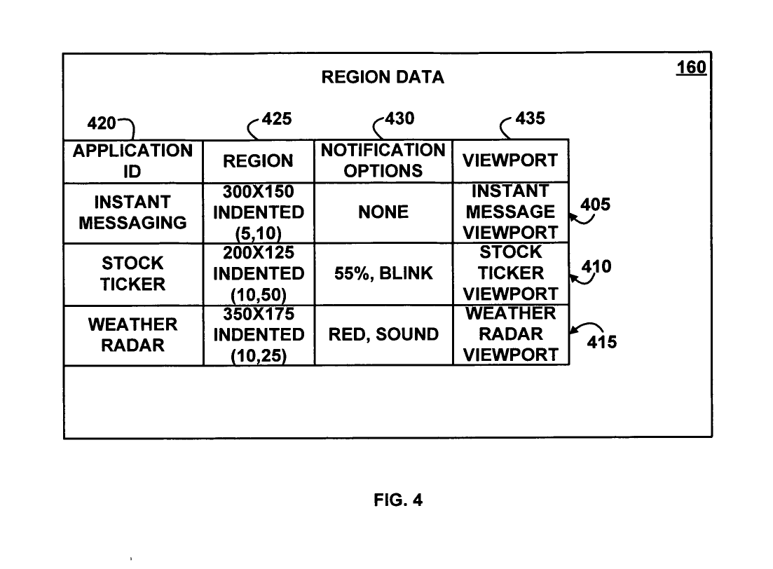

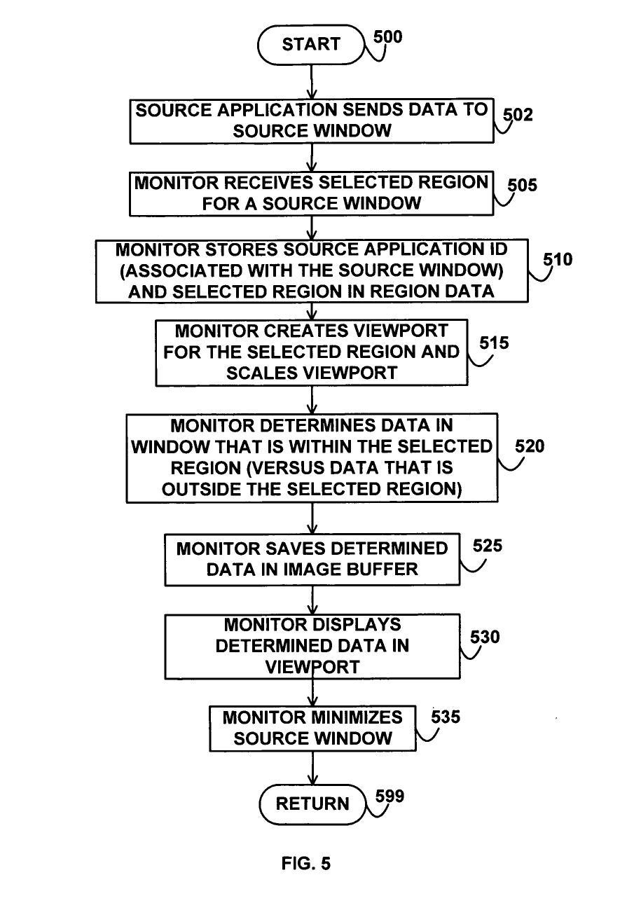

The source applications 152 create data that is displayed in windows on the display terminals 121, 122, 123, and/or 124. The image buffer 156 stores data displayed on one or more of the terminals 121, 122, 123, and/or 124. The monitor 154 creates a viewport for selected regions of the windows and displays data from the source applications 152 directed to those selected regions in the viewport. The monitor 154 includes instructions capable of executing on the processor 101 or statements capable of being interpreted by instructions executing on the processor 101 to perform the functions as further described below with reference to FIGS. 5, 6, and 7. In another embodiment, the monitor 154 may be implemented in microcode or firmware. In another embodiment, the monitor 154 may be implemented in hardware via logic gates and/or other appropriate hardware techniques in lieu of or in addition to a processor-based system. The region data 160 includes a specification of selected regions displayed in viewports. The region data 160 is further described below with reference to FIG. 4.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/0 bus 104 may be, e.g., an industry standard PCI bus, or any other appropriate bus technology.

The I/O interface units support communication with a variety of storage and I/O devices. For example, the terminal interface unit 111 supports the attachment of one or more user terminals 121, 122, 123, and 124. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O and other device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in,any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

The computer system 100 depicted in FIG. 1 has multiple attached terminals 121, 122, 123, and 124, such as might be typical of a multi-user “mainframe” computer system. Typically, in such a case the actual number of attached devices is greater than those shown in FIG. 1, although the present invention is not limited to systems of any particular size. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support Infiniband. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number (including zero) of networks (of the same or different types) may be present.

It should be understood that FIG. 1 is intended to depict the representative major components of the computer system 100 and the network 130 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the computer system 100, and that, when read and executed by one or more processors 101 in the computer system 100, cause the computer system 100 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the computer system 100 via a variety of signal-bearing media, which include, but are not limited to the following computer-readable media:

(1) information permanently stored on a non-rewriteable storage medium, e.g., a read-only memory storage device attached to or within a computer system, such as a CD-ROM, DVD−R, or DVD+R;

(2) alterable information stored on a rewriteable storage medium, e.g., a hard disk drive (e.g., the DASD 125, 126, or 127), CD-RW, DVD−RW, DVD+RW, DVD-RAM, or diskette; or

(3) information conveyed by a communications or transmissions medium, such as through a computer or a telephone network, e.g., the network 130.

Such signal-bearing media, when carrying or encoded with computer-readable, processor-readable, or machine-readable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

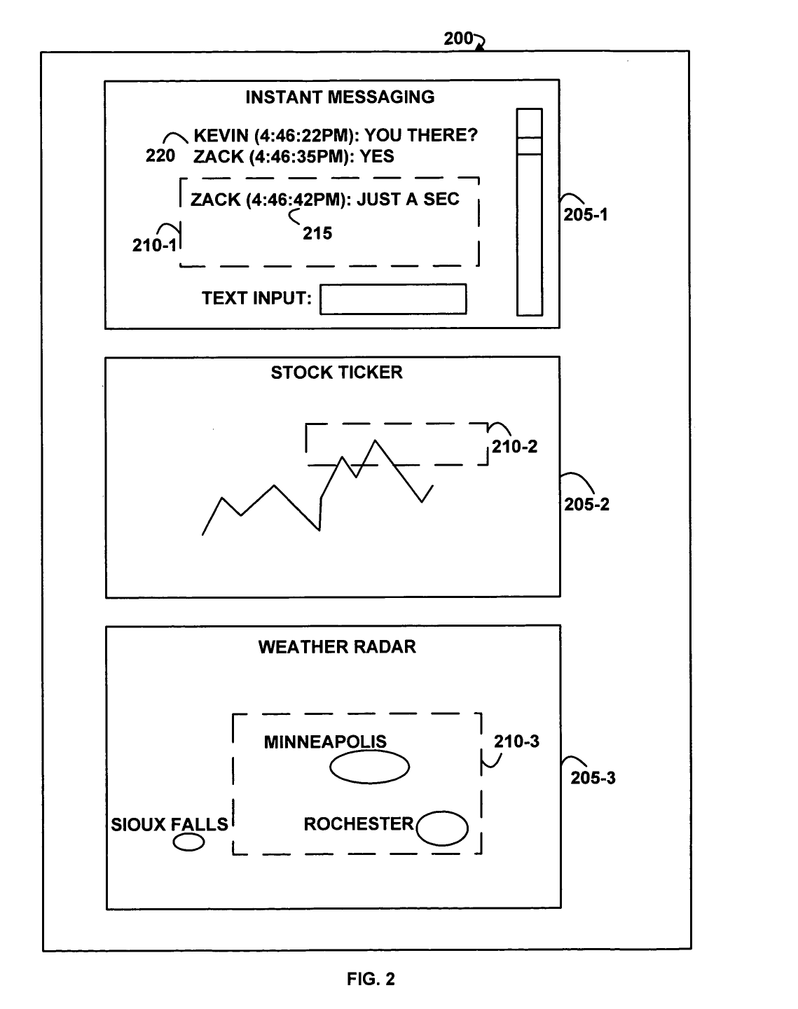

FIG. 2 depicts a block diagram of an example user interface 200 for creating selected regions 210-1, 210-2, and 210-3, according to an embodiment of the invention. The user interface 200 is displayed on one or more of the terminals 121, 122, 123, and/or 124, or any other display device, e.g., connected via the network 130. The user interface 200 includes source windows 205-1, 205-2, and 205-3. In various embodiments, the source windows 205-1, 205-2, and/or 205-3 may be implemented via parent windows, child windows, message windows, pop-up windows, frames, dialogs, scrollbars, widgets, buttons, dials, GUI components, pixels, any unit or units of a display screen, or any portion or combination thereof.

The source windows 205-1, 205-2, and 205-3 include respective selected regions 210-1, 210-2, and 210-3. The selected regions 210-1,210-2, and 210-3 are subsets of their respective source windows 205-1, 205-2, 205-3, so that the source window includes first data that is within the selected region and second data that is outside the selected region. For example, the source window 205-1 includes first data 215, which is within the selected region 210-1, and second data 220, which is outside of the selected region 210-1.

A user may select the selected regions 210-1, 210-2, and 210-3 via a keyboard, mouse, trackball, touchpad, trackpad, speech recognition device, or any other appropriate type of input device.

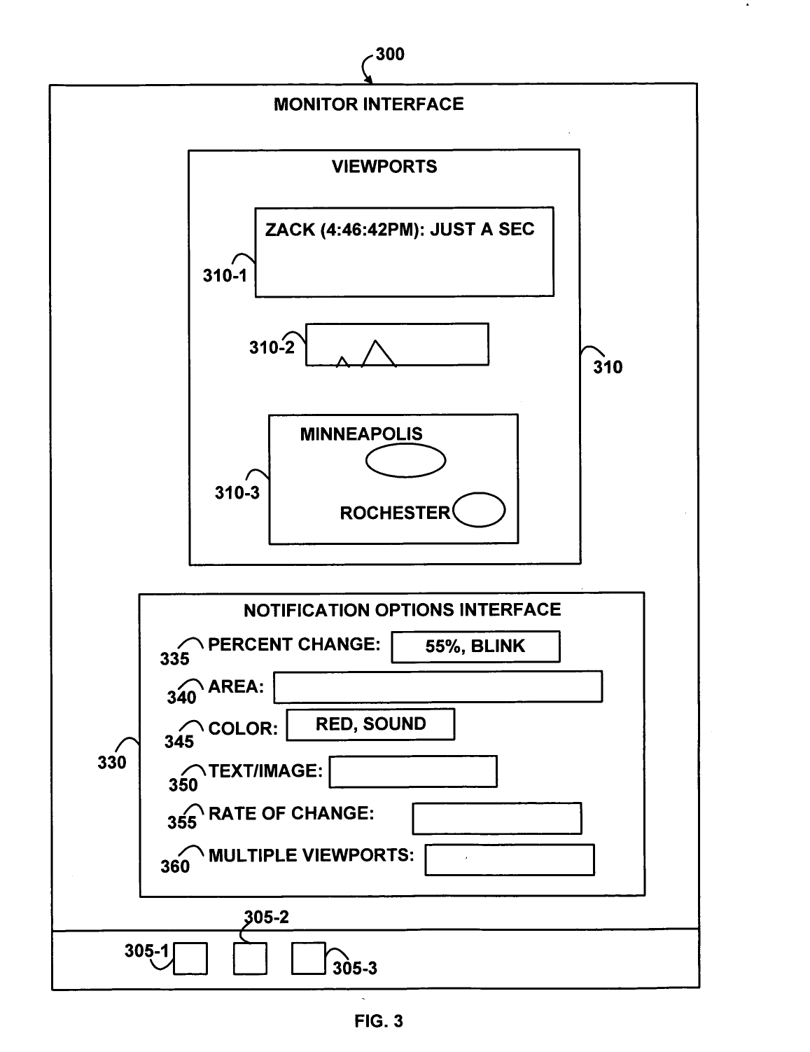

FIG. 3 depicts a block diagram of an example monitor user interface 300, according to an embodiment of the invention. The monitor user interface 300 is displayed on one or more of the terminals 121, 122, 123, and/or 124, or any other display device, e.g., connected via the network 130. The monitor user interface 300 includes viewports 310-1, 310-2, and 310-3, which are associated with respective regions 210-1, 210-2, and 210-3 of FIG. 2. But, in other embodiments any number of viewports with any appropriate data may be present. The viewports 310-1, 310-2, and 310-3 are generically referred to as the viewports 310. The source windows 205-1,205-2, and 205-3 (FIG. 2) are minimized in the monitor user interface 300 as respective icons 305-1, 305-2, and 305-3, which represent their respective windows, but which do not include the data presented in the viewports 310-1, 310-2, and 310-3.

The monitor user interface 300 further includes a notification options interface dialog 330, which allows the user to input optional notification criteria and notification techniques. The notification options interface 330 includes the example notification criteria and techniques 335, 340, 345, 350, 355, and 360. The notification criteria 335, 340, 345, 350, 355 and 360 specify a comparison function and threshold that the monitor 154 uses to determine if and when to notify the user that a change has occurred in a viewport 310 via the notification technique. In various embodiments, the notification criteria and techniques specified in the notification options interface 330 may apply to all of the viewports 310 or to selected of the viewports 310.

The notification technique specifies a method for communicating a change to the user and may include blinking the viewport or data in the viewport, a color of the viewport or data in the viewport, an audio sound, highlighting the viewport or data in the viewport, any portion or combination thereof, or any other appropriate technique.

The notification criteria 335 allows the user to specify a percent amount of data in the viewport 310. In response to the notification criteria 335, the monitor 154 compares the amount of data that was changed in the viewport 310 and if the amount exceeds the specified percent threshold, then the monitor 154 presents a notification that the notification criteria was fulfilled via the notification technique. In the example of FIG. 3, the monitor 154 causes the viewport 310 to blink (the notification techniques) if more than 55% of the data in the viewport 310 changes.

The notification criteria 340 allows the user to specify an area of the viewport 310. In response to the notification criteria 340, the monitor 154 compares new data to the previous data that was displayed in the viewport 310, and if the changed data is in a specified area (e.g., the bottom half, the top half, or any other specified area of the viewport 310), then the monitor 154 presents a notification that the notification criteria was fulfilled via the notification technique.

The notification criteria 345 allows the user to specify data of a specified color in the viewport 310. In response to the notification criteria 345, the monitor 154 compares new data to previously-displayed data in the viewport 310 and if the changed data has the specified color, then the monitor 154 presents a notification that the notification criteria was fulfilled via the notification technique. In the example of FIG. 3, the monitor 154 produces an audio sound (the notification technique) if red data changes in the viewport 310.

The notification criteria 350 allows the user to specify text or an image and optionally specify particular text or a particular image. In response to a notification criteria 350 of text, the monitor 154 compares new data to previously-displayed data in the viewport 310, and if the changed data is text, or is the specified text, then the monitor 154 presents a notification that the notification criteria was fulfilled via a notification technique. In response to a notification criteria 350 of image, the monitor 154 compares new data to previously-displayed data in the viewport 310, and if the changed data is an image, or is a specified image, then the monitor 154 presents a notification that the notification criteria was fulfilled via a notification technique.

The notification criteria 355 allows the user to specify a rate of change of data in the viewport 310. In response to the notification criteria 355, the monitor 154 compares new data to previously-displayed data in the viewport 310, and if the changed data is changed at a rate over time that is greater than a specified threshold, then the monitor 154 presents a notification that the notification criteria was fulfilled via a notification technique. For example, if the user specifies a notification technique of highlighting and a notification criteria that 50% of the displayed data in the viewport 310 must change over a five minute time span in order to receive a notification, then the monitor 154 samples the data in the image buffer 156 every five minutes and compares the percentage of data that has changed since that previous five minute interval to 50%. If more than 50% of the data has changed, then the monitor 154 presents a notification that the notification criteria was fulfilled via the notification technique of highlighting the viewport 310 or highlighting the data in the viewport 310 that was changed.

The notification criteria 360 allows the user to specify a threshold that was reached in multiple viewports 310. In response to the notification criteria 360, the monitor 154 compares new data to previously-displayed data in multiple viewports 310, and if the changed data fulfills a criteria or exceeds a threshold in all of the specified viewports, then the monitor 154 presents a notification that the notification criteria was fulfilled in all of the specified viewports via a notification technique.

FIG. 4 depicts a block diagram of an example data structure for the region data 160, according to an embodiment of the invention. The region data 160 includes records 405, 410, and 415, but in other embodiments any number of records with any appropriate data may be present. Each of the records 405, 410, and 415 includes an application identifier 420, a region identifier 425, notification options 430, and a viewport identifier 435, but in other embodiments more or fewer fields may be present.

The application identifier 420 identifies a source application 152, which is a source of data to the source window that contains the selected region identified by the region identifier 425. The region identifier 425 identifies a selected region in the source window, such as the selected regions 210-1, 210-2, or 210-3. In various embodiments, the region identifier 425 may be expressed as absolute coordinates, such as “300×15 pixel area indented (5,10) from origin,” as illustrated in the example of record 405. In other embodiments, the region identifier 425 may be expressed in terms of GUI components or any other appropriate technique for identifying selected regions. Additionally, default areas may be defined for particular source applications 152.

The notification options 430 may include a notification criteria and a notification technique. The notification criteria specify a comparison function and threshold that the monitor 154 uses to determine if and when to notify the user that a change has occurred in a viewport 310 via the notification technique. Example notification criteria may include a percent amount of data in the viewport that was changed, an area of the viewport that was changed, data of a specified color in the viewport that was changed, text in the viewport that was changed, an image in the viewport that was changed, a rate of change of data in the viewport, and a threshold that was reached in multiple viewports. The notification technique specifies a method for communicating a change to the user and may include blinking data, an audio sound, highlighting data, or any other appropriate technique. The monitor 154 sets the notification options 430 based on information received via the notification options user interface 330 (FIG. 3).

The viewport identifier 435 specifies a viewport 310, which is associated with the respective selected region 425. For example the viewport identifier 435 in the record 405 identifies the instant messaging viewport 310-1, the viewport identifier 435 in the record 410 identifies the stock ticker viewport 310-2, and the viewport identifier 435 in the record 415 identifies the weather radar viewport 310-3.

FIG. 5 depicts a flowchart of example processing for creating a viewport 310 (FIG. 3), according to an embodiment of the invention. The logic of FIG. 5 may be executed repeatedly for multiple source windows and viewports. Control begins at block 500.

Control then continues to block 502 where the source application 152 sends data to the source window (e.g., the source windows 205-1, 205-2, or 205-3 of FIG. 2) for display. Control then continues to block 505 where the monitor 154 receives a selected region of interest (e.g., the selected regions 210-1, 210-2, and 210-3) for a source window (e.g., the source windows 205-1,205-2, and 205-3) from the user interface 200.

Control then continues to block 510 where the monitor 154 stores an identifier of the source application that sends data to the source window and an identifier of the selected region in the region data 160 as the source application identifier 420 and the region 425.

Control then continues to block 515 where the monitor 154 creates the viewport 310 for the selected region and scales the viewport. Scaling the viewport changes the size of the viewport from the size of the selected regions 210-1, 210-2, and 210-3 (in FIG. 2) to the size of the viewports 310-1, 310-2, and 310-3 (in FIG. 3) that the user desires.

Control then continues to block 520 where the monitor 154 determines the data in the source window that is within the selected region (versus the data in the source window that is outside the selected region). An example of data within the selected region is the first data 215 in FIG. 2. An example of data in the source window but outside the selected region is the second data 220 in FIG. 2.

Control then continues to block 525 where the monitor 154 saves the determined data in the image buffer 156. The monitor 154 may save the determined data in the image buffer 156 via any appropriate technique. Control then continues to block 530 where the monitor 154 sends the determined data to the viewport 310 for presentation or display in the viewport 310.

Control then continues to block 535 where the monitor 154 minimizes the source window while the viewport 310 remains displayed. In an embodiment, the monitor 154 minimizes the source window by removing the source window from view and displaying an icon (e.g., the icons 305-1, 305-2, or 305-3) that represents the source window, where the content of the icon is different from and does not present the data of the viewport 310. Control then continues to block 599 where the logic of FIG. 5 returns.

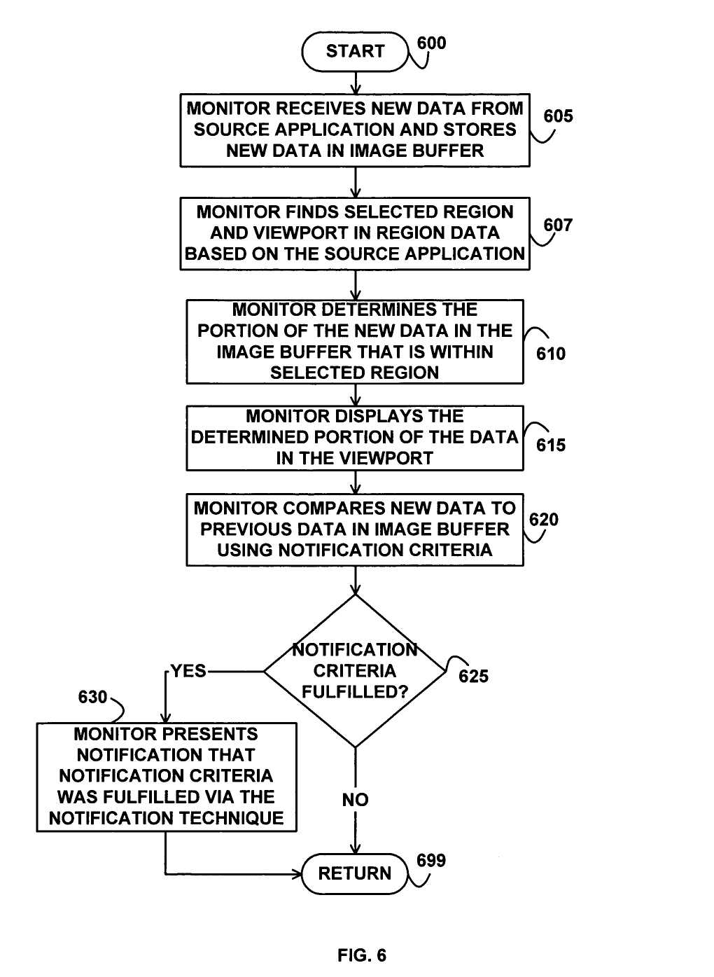

FIG. 6 depicts a flowchart of example processing for updating data in a viewport, according to an embodiment of the invention. Control begins at block 600. Control then continues to block 605 where the monitor 154 receives new data from the source application 152 (which the source application 152 was sending to the source window) and stores the new data in the image buffer 156. Control then continues to block 607 where the monitor 154 finds the region 425 and the viewport 435 in the region data 160 via the application identifier 420 of the source application 152 that sent the new data to the source window.

Control then continues to block 610 where the monitor 154 determines the portion of the new data in the image buffer that is within the region 425, as opposed to the portion of the new data that is outside of the region 425. Control then continues to block 615 where the monitor 154 displays the determined portion of the new data that is within the region 425 in the viewport 310, as previously described above with reference to FIG. 3.

Control then continues to block 620 where the monitor 154 compares the new data associated with the viewport (the portion within the region 425) to the previous data associated with the viewport in the image buffer 156 using the notification criteria specified in the notification options 430, if any. The monitor 154 may use any appropriate comparison technique for comparing the new data with the previous data.

Control then continues to block 625 where the monitor 154 determines whether the compare of block 620 resulted in the notification criteria specified in the notification option field 430 being fulfilled. If the determination at block 625 is true, then the notification criteria is fulfilled, so control continues to block 630 where the monitor presents the notification that the notification criteria was fulfilled via the notification technique, which is specified in the notification options 430. In an embodiment, the monitor 154 further associates notifications with an action and provides the user with an option to take an action or send a command to the source application 152. In the example of the stock ticker application of the viewport 310-2, the monitor 154 may present the user with the ability to buy or sell stock in response to the notification, but in other embodiments any appropriate action may be used. Control then continues to block 699 where the logic of FIG. 6 returns.

If the determination at block 625 is false, then the notification criteria is not fulfilled, so control continues to block 699 where the logic of FIG. 6 returns.

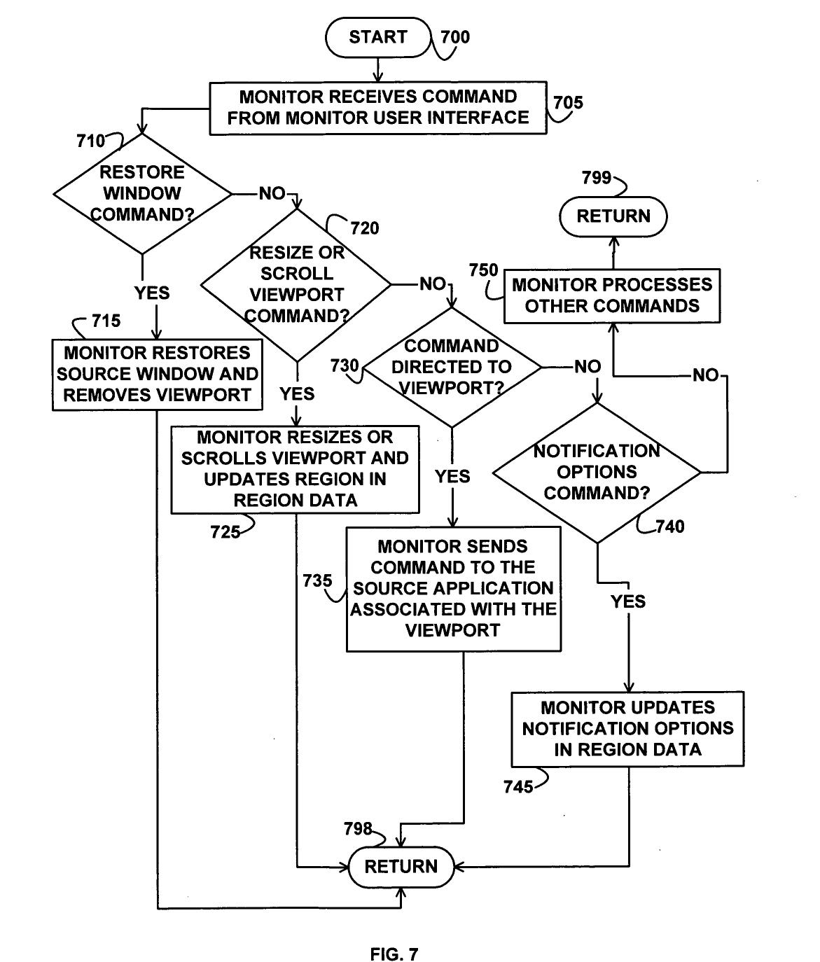

FIG. 7 depicts a flowchart of example processing for handling commands received via the monitor user interface 300, according to an embodiment of the invention. Control begins at block 700. Control then continues to block 705 where the monitor 154 receives a command via the monitor user interface 300. Control then continues to block 710 where the monitor 154 determines whether the received command is a restore window command. If the determination at block 710 is true, then the received command is a restore window command, so control continues to block 715 where the monitor 154 restores the source window (e.g., removes the icon 305-1, 305-2, or 305-3 and once again displays the associated source window 205-1, 205-2, or 205-3) and removes the viewport from display. Control then continues to block 798 where the logic of FIG. 7 returns.

If the determination at block 710 is false, then the received command is not a restore window command, so control continues to block 720 where the monitor 154 determines whether the received command is a resize or scroll viewport command. If the determination at block 720 is true, then the received command is a resize or scroll viewport command, so control continues to block 725 where the monitor 154 resizes or scrolls the viewport 310 and updates the region 425 in the region data 160 to reflect the new size and/or location of the selected region. A viewport may be resized by dragging edges of the viewport with a pointing device or via any other appropriate technique. A viewport may be scrolled via a scrollbar, via dragging content within the viewport with a pointing device, or via any other appropriate technique. Control then continues to block 798 where the logic of FIG. 7 returns.

If the determination at block 720 is false, then the received command is not a resize or scroll viewport command, so control continues to block 730 where the monitor 154 determines whether the received command is directed to a viewport 310. If the determination at block 730 is true, then the received command is directed to a viewport 310, so control continues to block 735 where the monitor 154 sends the received command to the source application 152 associated with the viewport to which the command is directed. In this way, the user may interact with the source application 152 without needing to toggle to the source window 205-1, 205-2, or 205-3 or restore the source window from its minimized state. Control then continues to block 798 where the logic of FIG. 7 returns.

If the determination at block 730 is false, then the received command is not directed to a viewport, so control continues to block 740 where the monitor 154 determines whether the received command is an notification options command received via the notification options interface dialog 330 (FIG. 3). If the determination at block 740 is true, then the received command is a notification options command, so control continues to block 745 where the monitor 154 updates the notification options 430 in the region data 160 with the notification criteria and notification technique specified in the notification options command. Control then continues to block 798 where the logic of FIG. 7 returns.

If the determination at block 740 is false, then the received command is not a notification options command, so control continues to block 750 where the monitor 154 processes other commands. Control then continues to block 799 where the logic of FIG. 7 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

What is claimed is:

1. A method comprising:
creating a viewport based on a selected region of a source window;
determining first data that is within the selected region;
displaying the first data in the viewport; and
removing the source window from view.

2. The method of claim 1, wherein a source application sends the first data to the selected region of the source window.

3. The method of claim 1, wherein the selected region of the source window comprises a subset of the source window, and wherein the source window comprises the first data in the selected region and second data that is outside the selected region.

4. The method of claim 3, wherein the removing the source window from view further comprises:
minimizing the source window via an icon that represents the source window, wherein the icon is different from the first data and the second data.

5. The method of claim 1, further comprising:
receiving third data from the source application, wherein the source application sends the third data to the source window;
determining whether the third data is within the selected region; and
if the determining is true, displaying the third data in the viewport.

6. The method of claim 5, further comprising:
comparing the third data to the first data; and
if the comparing fulfills a notification criteria, presenting a notification that the criteria was fulfilled.

7. The method of claim 6, wherein the notification criteria is selected from a group consisting of: a percent changed, an area that was changed, a color that was changed, text that was changed, an image that was changed, a rate of change, and a threshold was reached in multiple viewports.

8. A signal-bearing medium encoded with instructions, wherein the instructions when executed comprise:
creating a viewport based on a selected region of a source window;
determining first data that is within the selected region, wherein a source application sends the first data to the selected region of the source window, wherein the selected region of the source window comprises a subset of the source window, and wherein the source window comprises the first data in the selected region and second data that is outside the selected region;
displaying the first data in the viewport; and
minimizing the source window via an icon that represents the source window, wherein the icon is different from the first data and the second data.

9. The signal-bearing medium of claim 8, further comprising:
receiving third data from the source application, wherein the source application sends the third data to the source window;
determining whether the third data is within the selected region; and if the determining is true, displaying the third data in the viewport.

10. The signal-bearing medium of claim 9, further comprising:
comparing the third data to the first data; and
if the comparing fulfills a notification criteria, presenting a notification that the criteria was fulfilled via a notification technique.

11. The signal-bearing medium of claim 10, wherein the notification criteria is selected from a group consisting of: a percent changed, an area that was changed, a color that was changed, text that was changed, an image that was changed, a rate of change, and a threshold was reached in multiple viewports.

12. The signal-bearing medium of claim 8, further comprising:
scrolling the viewport; and
updating the selected region in response to the scrolling.

13. The signal-bearing medium of claim 8, further comprising:
restoring the source window; and
removing the viewport.

14. The signal-bearing medium of claim 8, further comprising:
receiving a command directed to the viewport; and
sending the command to the source application.

15. A method for configuring a computer, comprising:
configuring the computer to create a viewport based on a selected region of a source window;
configuring the computer to determine first data that is within the selected region, wherein a source application sends the first data to the selected region of the source window, and wherein the selected region of the source window comprises a subset of the source window, and wherein the source window comprises the first data in the selected region and second data that is outside the selected region;
configuring the computer to display the first data in the viewport;
configuring the computer to minimize the source window via an icon that represents the source window, wherein the icon is different from the first data and the second data, wherein the first data remains displayed in the viewport;
configuring the computer to receive third data from the source application, wherein the source application sends the third data to the source window;
configuring the computer to determine whether the third data is within the selected region; and
configuring the computer to, if the determining is true, displaying the third data in the viewport.

16. The method of claim 15, further comprising:
configuring the computer to compare the third data to the first data; and
configuring the computer to, if the comparing fulfills a notification criteria, present a notification that the criteria was fulfilled via a notification technique.

17. The method of claim 16, wherein the notification criteria is selected from a group consisting of: a percent changed, an area that was changed, a color that was changed, text that was changed, an image that was changed, a rate of change, and a threshold was reached in multiple viewports.

18. The method of claim 15, further comprising:
configuring the computer to resize the viewport; and
configuring the computer to update the selected region in response to the resizing.

19. The method of claim 15, further comprising:
configuring the computer to restore the source window; and
configuring the computer to remove the viewport.

20. The method of claim 15, further comprising:
configuring the computer to receive a command directed to the viewport; and
configuring the computer to send the command to the source application.
